(19) United States
(12) Patent Application Publication
(10) Pub. No.: US 2026/0186311 A1
(43) Pub. Date: Jul. 2, 2026

(54) Optical System for Generating High-Power Light

(71) Applicants: Friedrich-Schiller-Universität Jena, Jena (DE); GSI Helmholtzzentrum für Schwerionenforschung GmbH, Darmstadt (DE)

(72) Inventors: Jens LIMPERT, Jena (DE); Arno KLENKE, Jena (DE); César JÁUREGUI MISAS, Dornburg-Camburg (DE)

(21) Appl. No.: 19/120,112

(22) PCT Filed: Oct. 12, 2023
(86) PCT No.: PCT/EP2023/078322

§ 371 Date: Jun. 16, 2025

(30) Foreign Application Priority Data
Oct. 14, 2022 (DE) 102022126964.7

(51) Int. Cl. G02B 27/09; G02B 6/02; G02B 6/032; G02B 6/04; G02F 1/35

(52) U.S. Cl. CPC G02B 27/0905; G02B 6/02042; G02B 6/032; G02B 6/04; G02B 27/0994; G02F 1/3503

(57) ABSTRACT

The disclosure relates to an optical system for generating or guiding light, having a multi-channel light guide (1) with a plurality of individual light guides running parallel to one another, and having a superposing optical unit (2) which is designed to superpose light emissions from the individual light guides in a target plane (3) at an outlet end of the multi-channel light guide (1). The disclosure proposes that the superposition of the light emissions of the individual light guides is incoherent in the target plane (3). The insight of the disclosure is that the incoherent superposition of the individual emissions results in an effectively better, more homogeneous and more stable beam quality than when a surface-equivalent transversally multimode individual large-core fiber is used, e.g., as an amplification fiber of a laser system.

### CROSS-REFERENCE TO RELATED APPLICATIONS

This application is a national phase entry of International Patent Application No. PCT/EP2023/078322, filed Oct. 12, 2023, which claims priority to German Patent Application No. DE102022126964.7, filed Oct. 14, 2022, the content of each being incorporated herein by reference in its entirety for all purposes.

### TECHNICAL FIELD

The present disclosure generally relates to an optical system for generating high-power light, having a multi-channel light guide which comprises a plurality of individual light guides running parallel to one another, and having a superposing optical unit which is designed to superpose light emissions of the individual light guides in a target plane at an outlet end of the multi-channel light guide.

### BACKGROUND

High-power laser systems have numerous applications in industry and science. The spatial coherence of a laser's emission allows the radiation to focus on the smallest spatial areas. The ideal case is a diffraction-limited beam that produces the smallest focus spot for a given imaging optics. A poorer beam quality typically leads to a larger focus spot, therefore lower intensities, or requires the use of focusing optics with a larger numerical aperture (i.e., higher divergence angle of the radiation to the focus) and therefore reduces the Rayleigh length, i.e. the distance over which a high intensity can be maintained. The better the beam quality, the higher the achievable power densities, even at greater distances.

The achievable power densities determine the addressable applications. Continuously emitting high-power lasers are used, for example, for cutting and welding various materials (e.g., metals), among other things pulsed lasers are used to specifically ablate or modify materials. The excessive peak power densities of pulsed laser radiation also allow the driving of non-linear effects, e.g., the frequency conversion of primary laser radiation into other, application-relevant spectral ranges, i.e., the generation of secondary radiation. This frequency conversion can take place coherent (e.g., crystal-based frequency conversion in the form of the generation of higher harmonics, spectral broadening by Kerr non-linearity or generation of short-wave coherent radiation by gas harmonics in noble gases), but also incoherent (e.g., by laser-induced plasmas in gases or metals).

An example of an incoherent frequency conversion with high economic relevance is the generation of incoherent EUV radiation at 13.5 nanometer (nm) wavelength (92 electron volt (eV) photon energy) for applications in the semiconductor industry by laser-induced tin plasmas (see O. O. Versolato, “Physics of laser-driven tin plasma sources of EUV radiation for nanolithography,” Plasma Sources Sci. Technol. 28, 083001, 2019). In a powerful version, the radiation from a pulsed CO2 laser is focused onto tin droplets (approx. 30 micrometer (μm) in diameter). The resulting plasma emits incoherently in all spatial directions at a wavelength of 13.5 nm, the conversion efficiency of this process can be 3-6% (also by targeted pre-preparation of the target by means of pre-pulsing).

Another industrial process selected as an example is laser shock peening for extension of the service life of components (see C. Zhang, Y. Dong, and C. Ye, “Recent Developments and Novel Applications of Laser Shock Peening: A Review,” Adv. Eng. Mater. 23, 2001216, 2021). A compressive stress is introduced into the material to counteract fatigue caused by tensile stresses. In laser peening, a pressure wave is generated using a high-energy laser pulse. Hereby pulse energies of several 100 millijoule (mJ) to a few joules with focus spot diameters of a few millimeters are used. The homogeneity of the beam profile is essential for homogeneous pressure input. The process speed is determined by the pulse repetition frequency, which is the reason for striving for higher pulse repetition frequencies.

Another selected application example of high-energy nanosecond pulses is the laser lift-off process (see R. Delmdahl, R. Patzel, and J. Brune, “Large-Area Laser-Lift-Off Processing in Microelectronics,” Phys. Procedia 41, 241-248, 2013). In this process, a functional film (e.g., a display) is produced over a large area on a solid carrier (substrate). The laser lift-off process enables the separation of film and substrate with the necessary reproducibility and protection of the film. High-energy nanosecond pulses in the ultraviolet (UV) spectral range are used, which penetrate the substrate and are absorbed by an absorbent layer. The resulting energy input leads to the detachment of the film. The spatial homogeneity of the energy input is essential for this process.

Another example of the application of high-energy laser radiation is the lithotripsy, i.e., the fragmentation of kidney stones or bladder stones (see N. M. Fried, “Recent advances in infrared laser lithotripsy [Invited],” Biomed. Opt. Express 9, 4552, 2018). High-energy long laser pulses in the Joule range are used for this purpose, for example, at a wavelength of around 2 μm due to tissue absorption.

The laser technology used today for these applications has the following disadvantages:
The aforementioned high-power CO2 laser has an overall efficiency (wall-plug efficiency) of only a few percent (see K. Kellens, G. Costa Rodrigues, W. Dewulf, J. R. Duflou, G. C. Rodrigues, W. Dewulf, and J. R. Duflou, “Energy and resource efficiency of laser cutting processes,” Phys. Procedia 56, 854-864, 2014).
Diode-pumped solid-state lasers offer significantly higher efficiency, but suffer from thermo-optical problems with increasing output power, which manifest themselves in a deterioration of the beam quality and thus of the focusability and beam homogeneity.
High pulse energies require a large cross-section of the active medium. In solid-state lasers (including fiber lasers), this leads to the oscillation of higher-order transverse modes, which in turn leads to a deterioration in beam quality and beam homogeneity.

Especially in fiber-based lasers (but also in passive transport fibers), the different transverse modes of a multi-mode fiber (large cross-section) are coherent to each other, i.e., the smallest changes in the relative phase position of the different transverse modes lead to changes in the spatial emission profile and thus ultimately to instabilities in the application process (see. B. Y. Zel'dovich, D. Z. Anderson, and M. A. Bolshtyansky, “Stabilization of the speckle pattern of a multimode fiber undergoing bending,” Opt. Lett. Vol. 21, Issue 11, pp. 785-787 21, 785-787, 1996).

### SUMMARY OF THE DISCLOSURE

The present disclosure relates to an optical system for generating high-power light, having a multi-channel light guide which includes a plurality of individual light guides running parallel to one another, and also includes a superposing optical unit which is designed to superpose light emissions of the individual light guides in a target plane at an outlet end of the multi-channel light guide, wherein the superposition of the light emissions of the individual light guides in the target plane is incoherent.

### BRIEF DESCRIPTION OF THE DRAWINGS

Aspects of the present disclosure are explained in more detail below with reference to the drawings showing exemplary embodiments. In the drawings:

FIG. 1 shows example experimental proof of the incoherent superposition of a total emission consisting of several individual emissions in a common focus spot, in accordance with aspects of the present disclosure;

FIG. 2 shows generation of different beam profiles by incoherent superposition, in accordance with aspects of the present disclosure;

FIG. 3 is a schematic representation of a first example optical system, in accordance with aspects of the present disclosure;

FIG. 4 is a schematic representation of a second example optical system, in accordance with aspects of the present disclosure;

FIG. 5 is a schematic representation of a third example optical system, in accordance with aspects of the present disclosure;

FIG. 6 is a schematic representation of a fourth example optical system, in accordance with aspects of the present disclosure;

FIG. 7 is a schematic representation of a fifth example optical system, in accordance with aspects of the present disclosure;

FIG. 8 is a schematic representation of a sixth example optical system, in accordance with aspects of the present disclosure;

FIG. 9 is a schematic representation of a seventh example optical system, in accordance with aspects of the present disclosure;

FIG. 10 is a schematic representation of an eighth example optical system, in accordance with aspects of the present disclosure;

FIG. 11 is a schematic representation of a ninth example optical system, in accordance with aspects of the present disclosure;

FIG. 12 is a schematic representation of a tenth example optical system, in accordance with aspects of the present disclosure;

FIG. 13 shows example configurations of a multi-channel light guide, in accordance with aspects of the present disclosure;

FIG. 14 shows additional example configurations of a multi-channel light guide, in accordance with aspects of the present disclosure;

FIG. 15 shows additional example configurations of a multi-channel light guide, in accordance with aspects of the present disclosure;

FIG. 16 shows additional example configurations of a multi-channel light guide, in accordance with aspects of the present disclosure;

FIG. 17 shows additional example configurations of a multi-channel light guide, in accordance with aspects of the present disclosure; and

FIG. 18 shows an example of incoherent frequency conversion using an optical system, in accordance with aspects of the present disclosure.

### DETAILED DESCRIPTION OF THE DRAWINGS

Starting from an optical system of the type described above the superposition of the light emissions of the individual light guides in the target plane is incoherent.

Proposed is the incoherent superposition of the light emissions of the individual light guides which form the individual channels of the multi-channel light guide. For example, the beam quality should be good, i.e., the light emissions of the individual light guides are ideally (almost) diffraction-limited. For example, the individual emissions at the outlet end of the multi-channel light guide can be positioned as close as possible to each other.

A multi-channel light guide in the sense of the disclosure is any arrangement of a plurality of optically guiding structures running parallel to one another as individual light guides. Whereby the individual light guides of the multi-channel light guide have outlet ends in a common plane, which together form the outlet end of the multi-channel light guide. Examples of suitable multi-channel light guides are known from the prior art (see A. Klenke, C. Jauregui, A. Steinkopff, C. Aleshire, and J. Limpert, “High-power multicore fiber laser systems,” Prog. Quantum Electron. 84, 100412, 2022).

The number of individual light guides of the multi-channel light guide can be two or more, for example, the number is at least three, for another example, at least 8, for yet another example, at least 20, for a further example, at least 40. In principle, any number is conceivable.

In an embodiment, the individual light guides are each formed by a light-guiding core or by another light-guiding structure, which can be surrounded by a common cladding of the multi-channel light guide. At least one of the light-guiding cores, for example, only a part of the light-guiding cores, but for example, all of the light-guiding cores can have a doping with ions of rare earth, for example, erbium, ytterbium or thulium, to enable optical amplification. The common cladding can be, for example, designed to guide pump light for optical pumping the at least one doped core.

An insight of the disclosure is that an effectively better and significantly more stable beam quality can be achieved by the incoherent superposition of the individual emissions than, for example, when using an area-equivalent single transverse multimode large-core fiber, e.g., as an amplifier fiber of a laser system. An area-equivalent multimode fiber has the identical core cross-sectional area as all the individual cores of the multichannel light guide together. Assuming identical doping concentrations, this results in an identical fiber length. Consequently, both geometries (multi-channel light guide and multimode fiber) are comparable in terms of stored energy and extractable laser power, limiting nonlinear effects and fiber destruction due to excessive power densities. However, it has been shown that the area-equivalent multimode fiber has a poorer beam quality even with a low numerical aperture. The following should be taken into account:
As already mentioned, the beam quality of the emissions of the individual light guides of the multi-channel light guide of the disclosure should be as good as possible, ideally almost diffraction-limited. The diffraction index of the individual emissions should accordingly be less than 3, for example, less than 2, for another example, less than 1.5, for yet another example, less than 1.25. The directions of the individual emissions are, for example, parallel to each other.
The cross-section of the cores of the individual light guides should, for example be designed as large as possible at a given distance and taking into account the single core beam quality. Hereby geometries such as tapered large-core fibers or other known large-core fiber designs, which are known to support the best beam quality even with large core areas, can be helpful. The cores of the individual light guides should, for example, have a diameter greater than 5 times, for another example, greater than 10 times, for yet another example, greater than 25 times, for another example, greater than 50 times the wavelength of the propagating light.
The distance of the individual cores should, for example, be as small as possible taking into account the avoidance of optical coupling. In this case, optical barriers within the structure of the multi-channel light guide can be helpful to avoid overcoupling. In the sense of the disclosure, “optical decoupling of the individual light guides” means that, for example, less than 10%, for another example, less than 5%, for yet another example, less than 1% of the power propagating in an individual light guide is lost over the total length of the multi-channel light guide due to power transfer to other individual light guides.

The incoherent superposition of the individual emissions is an optical transformation of an arbitrary cross-sectional plane in the beam path, which is located in an area behind the outlet end of the multi-channel light guide.

It should be noted that the benefits of the multi-channel light guide over a multi-mode large-core fiber come into play when the spatially coherently emitting individual light guides are arranged tightly, so that the total area of the ultimately incoherent superposition of the coherent individual emissions does not become unnecessarily large. These design guidelines can be specifically implemented in a multicore fiber, since the known concept of the multi-core fiber ideally supports a dense packing of the individual cores. Ideally, in the case of the multi-channel light guide, the ratio of the distance of the cores of the individual light guides to the diameter of the cores should be less than 20, for example, less than 10, for another example, less than 5, for yet another example, less than 3.

Beneficial aspects of the disclosure may include:
The optical system has a simple and compact design.
In a fiber-based realization, the optical system of the disclosure as a laser system (see below) offers a high efficiency and it is possible to pump the multi-channel light guide as a laser medium directly with semiconductor diodes.
The geometry of the multi-channel light guide as an elongated waveguide, e.g., in form of an active multi-core fiber in a laser system (see below), distributes the laser-induced heat input over a large length, the large fiber cladding area can be used to dissipate the introduced heat. Consequently, the approach offers the possibility of emitting high average powers.
The inversion stored in the doped cores and therefore the extractable light output is determined by the properties of the dopants and the doping concentration, which defines and limits the extractable light power for each individual light guide. The multi-channel light guide increases the extractable power according to the number of individual light guides.
Various rare earths are possible dopants, ytterbium ions can address the wavelength range around 1 μm, erbium ions around 1.5 μm and thulium ions around 2 μm. It is also conceivable that the light-conducting cores differ from each other in terms of doping. This makes it possible to achieve a (optionally also dynamic) change in the emission wavelength by selecting the pump wavelength.
Requirements regarding non-linear effects and material degradation are distributed over several individual light guides, which in turn enables an increase in overall performance.
According to the disclosure, the superposition of the individual emissions is an incoherent superposition, i.e., the relative phase position of the individual emissions plays no role. Thus, elements for detecting and stabilizing the phase position in the individual channels are omitted, as are required in a coherent superposition. The design is therefore extremely simple thanks to the disclosure.
Due to the incoherent superposition, the exact position of the individual light guides over the cross-section of the multi-channel waveguide is not relevant, so there is a great deal of freedom in the design of the multi-channel waveguide. There are also large tolerances in production with regard to the positional accuracy and size of the individual light guides.
The beam quality of the incoherently superposed total emission of the multi-core light guide can, as already mentioned above, be significantly better compared to an area-equivalent multimode fiber

These benefits make the optical system according to the disclosure, realized as a laser system, i.e., with the multi-channel light guide as laser medium, for example suitable for the applications mentioned above, namely the incoherently superposed laser radiation generated with it can be used for generating UV light (e.g., EUV light) from a laser-induced metal plasma or gas plasma (e.g., tin plasma), for material processing by laser shock peening, for separating a film from a substrate by laser lift-off, or also for the generation of laser pulses for fragmentation of kidney or bladder stones (lithotripsy).

The benefits mentioned also apply unreservedly to an optical system with a purely passive multi-channel light guide (without core doping), e.g. as a transport fiber. In addition to the beam quality, the following is also relevant: In conventionally used passive multimode transport fibers, the intrinsic coherence of different transversal modes to each other results in a high sensitivity of the resulting intensity profile to relative changes in the phase position of the individual transversal modes. In passive multimode fibers, these phase changes have their origin in external influences (e.g., stress due to change in position or touching of the fiber); in active fibers, the laser-induced heat input dominates. These disadvantages are eliminated by the disclosure.

In an embodiment, the cores of the individual light guides can have different diameters. At least one of the cores can also be designed as a hollow core.

In another embodiment, the individual light guides are individual doped light-conducting fibers, for example, (doped with rare earth ions) double-core fibers, or also individual passive light-conducting fibers that are combined in the multi-channel light guide, as it were, as a bundle of single fibers.

The overlay optics of the optical system can be variable and designed to generate different beam profiles in the target plane, optionally dynamically.

In an embodiment, the individual light guides have a linear arrangement or an array-shaped or matrix-shaped arrangement in the cross-section of the multi-channel light guide. The “packing density” of the individual light guides can also be increased by a hexagonal arrangement. A random distribution of the individual light guides across the cross-section of the multi-channel light guide is also conceivable. Furthermore, to increase the fill factor, i.e., the cross-sectional proportion through which light passes, it is conceivable to (subsequently) expand the mode field diameter of the individual cores (e.g., by targeted heat input, i.e., thermal expansion or tapering of the multi-core fiber) at the inlet and/or outlet end of the multi-channel light guide.

Another approach for increasing the fill factor of the multi-core emission is the use of a lens array, for example a microlens array outside the multichannel light guide. This can be placed, for example, directly in front of the outlet end of the multi-channel light guide (at a corresponding working distance), but also in the further course of the beam path. Each individual lens of the lens array corresponds in each case to one or more individual light guides of the multi-channel light guide. By means of the lens array, the fill factor can be increased by at least the factor 1.2, for example by at least the factor 1.5, for another example by at least the factor 2, higher factors are also possible.

In an embodiment, the individual light guides of the multi-channel light guide each form a laser medium in an optical resonator. If no coupling takes place between the individual light guides, all individual light guides can be brought to laser emission independently of one another. Thus, one or more free beam resonator(s) can be placed around the multi-channel light guide (by means of a suitable reflector arrangement), which is/are used by all individual light guides, but each individual light guide performs the laser oscillation on its own, i.e., independently of the other individual light guides. This allows the incoherence of the superposition in the target plane to be achieved. It is also conceivable that independent optical resonators can be realized by reflectively coated end surfaces of the individual light guides or by Bragg gratings (FBGs) inscribed in the ends of the individual light guides. Even the Fresnel reflection at the free ends of the individual light guides can be sufficient for the formation of an optical resonator without further measures.

Further elements can also be arranged in the resonator or outside the resonator, e.g., (temporal) light modulators for generating pulsed laser radiation (by quality switching, cavity dumping or mode coupling).

An oscillator-amplifier arrangement (MOPA) can also be realized. Here, for example, a laser oscillator designed according to the disclosure with a multi-channel light guide generates laser radiation of low power, whereby the emission pattern consists of beams that are spatially incoherent with one another. The laser oscillator can operate (by means of a suitable modulation scheme) in a temporal operating regime according to the requirements of the application (continuous emission (cw) or pulsed up to ultrashort laser pulses). Alternatively, a conventional single emitter can be used as the light source, whereby its emission is divided accordingly between the individual light guides of the multi-channel light guide. The laser light generated in this way is coupled downstream into a laser-active multi-channel light guide with the appropriate number and arrangement of individual light guides and amplified therein to higher powers (and possibly pulse energies). This step can also be repeated i.e. further multi-channel light guides can be run through in series as amplifiers. The pattern of individual emissions can also be coupled into a multi-channel light guide serving as a passive transport fiber. Thus, the individual emissions can then be transported to the application. Frequency conversion processes can also be driven in the individual light guides of a multi-channel light guide downstream of the amplifier (e.g., four-wave mixing or Raman scattering).

When using a single emitter as a light source in an optical system of the disclosure realized as a MOPA system, for the incoherent superposition at the output of the downstream multi-channel light guide, the path lengths of the individual emissions up to the superposition in the target plane are greater than the coherence length of the light originating from the single emitter. Thus, all light sources with sufficiently large spectral width are conceivable, e.g., the (optionally time-stretched) emission of a mode-coupled ultrashort pulse laser or a super-luminescence diode.

In the MOPA concept, a light modulator (e.g., arranged between oscillator and amplifier) can modify the temporal characteristic of the emission, e.g., in order to generate pulses from a temporally continuous laser light or to adapt pulse shapes to the requirements of the application (e.g., to generate pre-pulses or an over-elevation at the beginning of a pulse) or to shape the pulses in order to influence saturation-related pulse shaping in the amplifier.

The described approach also offers the possibility that the emissions of the individual light guides take place independently of one another in time, e.g., by independent temporal modulation of the laser light in the individual channels of the multi-channel light guide. Thus, it is conceivable, for example, to generate one or more pre-pulses from a certain number of individual light guides and to emit a higher-energy main pulse from further individual light guides. For this purpose, only a time-shifted coupling of light pulses into the various individual light guides is required. It is also possible, e.g., by suitable different doping of the individual light guides or through corresponding frequency modulation of the pump light, for the pre-pulses to have an emission wavelength different from the main pulse. An embodiment provides that the cores of the individual light guides have different diameters, as a result of which the one or more pre-pulse(s) and the main pulse produce different spot sizes from one another in the incoherent superposition. In an embodiment, one or more of the individual light guides are formed with a hollow core, which is suitable, for example, for transporting ultrashort laser pulses of high peak pulse power, surrounded by further individual light guides of the active or passive multi-channel light guide.

In an embodiment, the optical system can comprise two or more multi-channel light guides, whereby the respective superposing optical units are designed to superpose the total emissions of the two or more multi-channel light guides in a spatial area. For example, the individual emissions can enter the spatial area from different spatial directions and be superposed there incoherently.

The total emission of the optical system can also be a superposition of the emissions of two multi-channel light guides of orthogonal polarization on one polarizer. Furthermore, the total emission can be a superposition of the emissions of two or more multi-channel light guides of different wavelengths on one or more spectrally selective elements (e.g., volume Bragg grating, dichroic mirror, prism, grating, grism or a combination of these elements).

In an embodiment, a non-linear optical element can be provided for frequency conversion of the superposed light emissions of the individual light guides. The frequency conversion can take place conventionally crystal-based (generation of the second or third harmonics, etc.) or also in a laser-induced plasma (e.g., in gaseous targets or in metallic targets, such as tin targets for generating EUV radiation at a wavelength of 13.5 nm). This approach provides that is particularly advantageous because the emission of the plasma is spatially incoherent and therefore no spatially coherent radiation is required for the nonlinear process. As prerequisite for an efficient frequency conversion it is sufficient that the necessary light intensity is achieved.

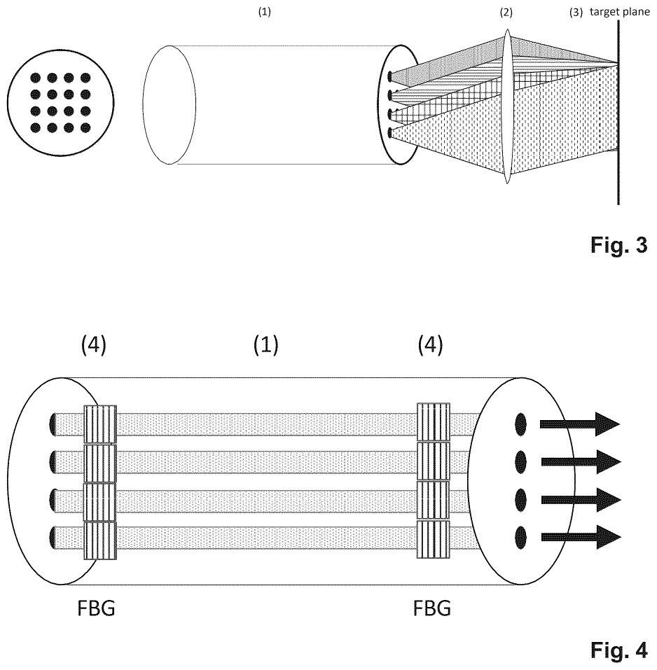

FIG. 3 shows the basic structure of an optical system according to the disclosure. It comprises a multi-channel light guide 1, which comprises a plurality of individual light guides running parallel to one another, here in an array-shaped arrangement with 4×4 individual light guides (to recognize in the cross-sectional view on the left). The individual light guides are each formed by a light-conducting core (dark circle), which is surrounded by a common (here circular in cross-section) cladding of the multi-channel light guide 1. A superposing optical unit 2 is provided to incoherently superpose the diverging light emissions of the individual light guides at the outlet end of the multi-channel light guide 1 (in FIG. 3 the right end of the multi-channel light guide 1) in a target plane 3. As can be seen, the light beams of the individual emissions meet at different angles in the target plane 3.

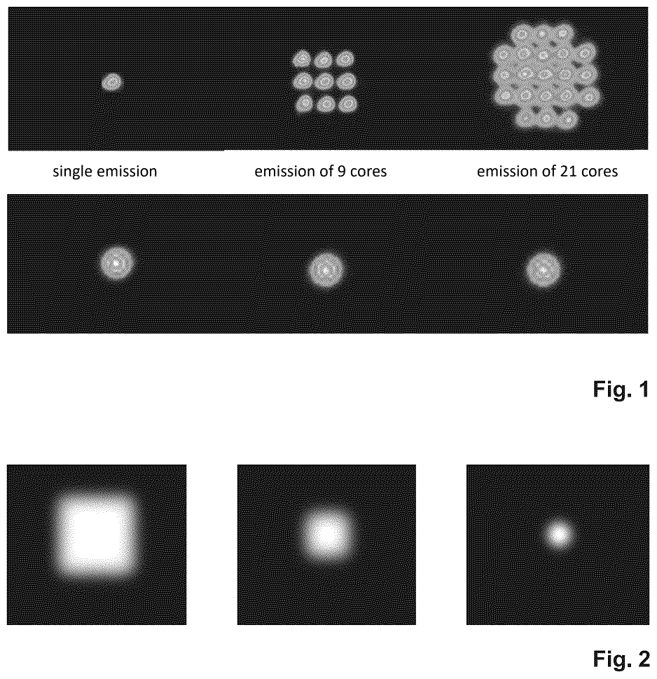

As explained above, the superposed light from the individual emissions of the multi-channel light guide 1 is characterized by a high beam quality compared to that of an area-equivalent multi-mode fiber. A further aspect illustrated in FIG. 1, is the homogeneity and the stability of the resulting focus in the target plane 3 or at the point of use. By way of example, the individual emissions can be adapted with a 4f image in their dimensions, e.g., enlarged, whereby the relations of the diameters of the individual emissions to the distances of the individual emissions remain unchanged. A further lens focuses these parallel running individual emissions into the target plane 3 of the application. In doing so the beam of each individual emission is focused. The different beams hit thereby the same focus spot at different angles and overlap there incoherently. This leads to an intensity distribution in the focus spot with a correspondingly added power density. The increase in power density at the point of use is therefore “bought” by an increased angular spectrum; this angular spectrum results from the lateral expansion of the individual emissions forming the total emission, as explained above. In FIG. 1, which in each case shows a cross-section of the beam path, the emission of an ytterbium-doped multi-channel light guide according to the disclosure (28 μm mode field diameter, core-to-core distance 82 μm) was enlarged by a factor of 33 using a lens system and focused on the target plane 3 using a further lens (f=40 mm). The upper row of images in FIG. 1 shows the emission of a single individual light guide/core (left), an array of nine single light guides/cores (center) and an array of 21 individual light guides/cores (right). The lower row of images shows that the incoherent superposition generates a homogeneous Gaussian-shaped intensity profile, the size of which does not change when further individual emissions are added (spot diameter approx. 70 μm). Assuming a uniformly distributed light power in the individual light guides, the power density is increased by a factor of 21 (equal to the number of cores).

In comparison, the imaging of a multi-mode fiber cannot generate such a homogeneous intensity distribution in the focus due to the coherence of the individual transverse modes to each other and the different phase imposed during the propagation of the radiation in the multimode fiber. A speckle pattern is always generated, which changes over time due to the change in the relative phase position of different transverse modes (e.g., due to smallest disturbances). This makes the generated light unusable for many applications. The disclosure provides a remedy here.

The basic approach of the disclosure illustrated in FIG. 3 also offers the possibility of generating a wide variety of beam profiles and dynamically switching between them. By corresponding incoherent beam superposition behind the multi-channel light guide the beam profiles shown in FIG. 2 are obtained by way of example. The beam profile is determined by suitable optics. Shown is in each case the incoherent superposition of an array of 10×10 individual emissions (individual Gaussian beams with diameter of 60 μm and 150 μm spacing) at various distances behind a lens, which is located at the distance of its focal length (here 60 mm) from the outlet end of the multi-channel waveguide 1. Each of these temporally stable and spatially homogeneous patterns (left: flat-top, center: super Gaussian profile, right: Gaussian profile) can be imaged with a corresponding imaging optics onto a target plane 3 with corresponding target dimensions and—according to the emitted power characteristics of the individual emissions—an associated target power density. In addition to small spot sizes and thus high power densities, spatially flat (flat-top) profiles (e.g., highest pulse energy for laser shock peening) can also be provided for the respective application. By adjusting the imaging optics, it is possible to switch between these profiles, even dynamically.

The proposed approach also offers the possibility of doping the individual light guides with different dopants and thus changing the emission wavelength by switching the pump wavelength (e.g., between 793 nm for thulium and 910-980 nm for ytterbium), whereby all emissions nevertheless represent the incoherent superposition and thus generate a flat-top beam or a focus that can be modulated in its wavelength.

FIG. 4 illustrates an embodiment of a multi-channel light guide as a laser oscillator, which in its simplest version emits continuous laser radiation. The laser resonator around the actively doped (e.g. with ytterbium, erbium or thulium ions) individual light guides, whose cores (shown hatched in FIG. 4) are integrated in a common pump cladding, can be formed, for example, by coated end surfaces or Fresnel reflections at the end surfaces of the individual light guides. The laser resonators of the individual light guides can also be formed by introduced fiber Bragg gratings 4 (FBGs), whereby the inscription of the FBGs can take place independently in each core, but is also possible over the entirety of the individual cores. The FBGs form an independent resonator for each core, which ensures incoherent emission from core to core.

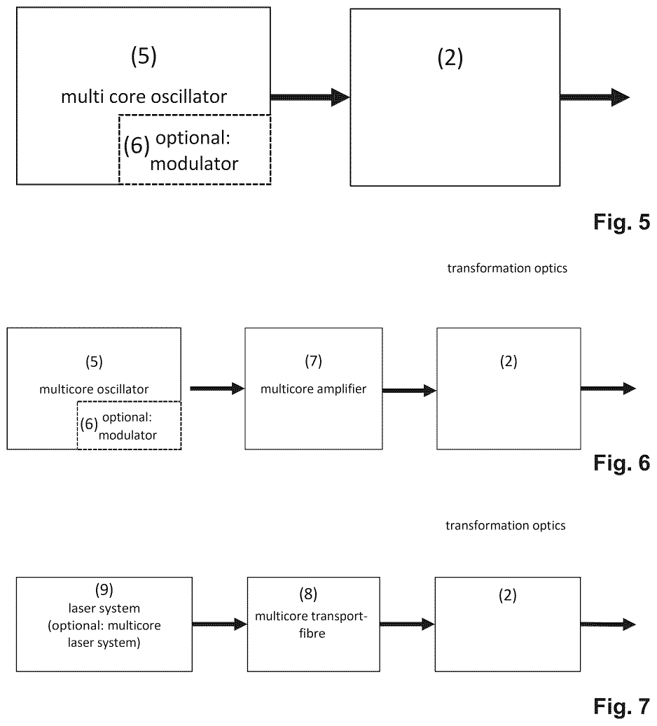

FIG. 5 shows an embodiment that includes generation of mutually incoherent pulsed radiation of the individual emissions of the actively doped multi-channel light guide (multi-core oscillator 5). A modulator 6, e.g., an active (e.g., acousto-optical or electro-optical) modulator or a passive amplitude modulator (e.g., a saturable absorber), can optionally be introduced for this purpose. The time-modulated individual emissions then propagate through a superposed optical system 2 to the target plane 3 (not shown here).

In the embodiment of FIG. 6, the continuous or pulsed individual emissions generated by the multi-core oscillator 5 are amplified in one or more further actively doped multi-channel light waveguides (multi-core amplifier 7). This is followed by incoherent superposition using superposing optical unit 2.

In the embodiment of FIG. 7, the emissions of a laser system 9 are transported in the individual light guides of a passive multi-channel light guide (multi-core transport fiber 8). For this purpose, the emission of the laser system 9, optionally a multi-core laser system, e.g., consisting of multi-core oscillator 5 and multi-core amplifier 7), can be coupled into the multi-core transport fiber 8 (free beam coupling or fiber connection by a splice) and guided in this, e.g., to the application. This is followed again by incoherent superposition using superposing optical unit 2.

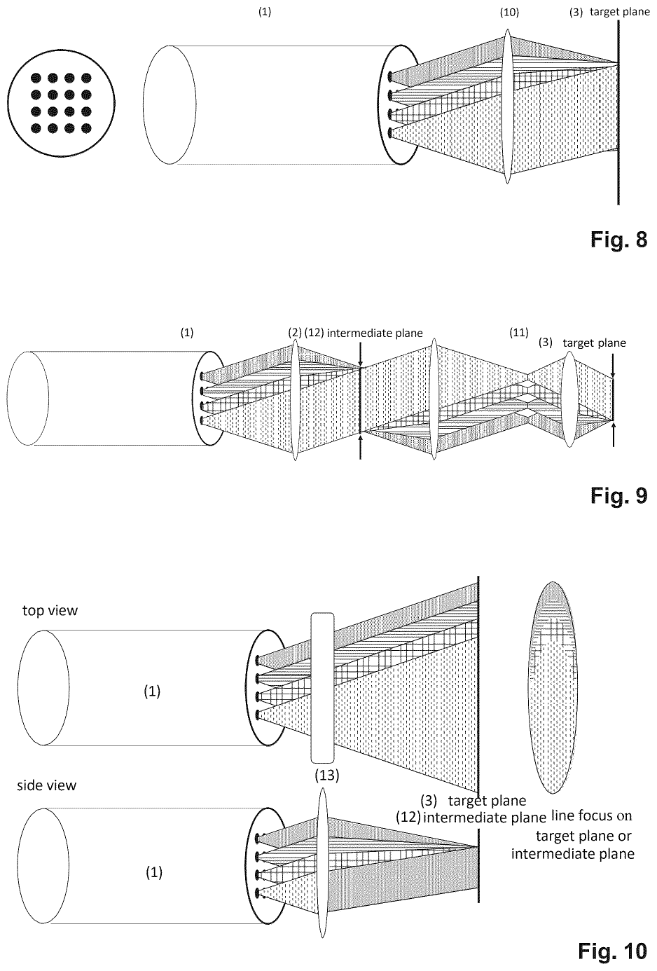

The incoherent superposition can be achieved using different superposing optical units 2. The simplest example is a single lens 10, which superposes the different emissions in the target plane 3. FIG. 8 shows an example of this superposition using a multi-channel light guide (multi-core fiber) with 16 signal cores in a 4×4 arrangement.

In order to adjust the size or spatial extent of the superposition and thus the intensities generated, a further optical system 11 (e.g., a telescope consisting of two lenses) can be used, as shown in FIG. 9, which images an intermediate plane 12 onto the target plane 3.

In FIG. 10, the superposition is performed by a cylindrical lens 13, adapted to produce an elliptical beam in the intermediate plane 12 or the target plane 3; with the focal length of the cylindrical lens 13 selected accordingly and the spacing of the elements, a homogeneous line focus results. FIG. 10 shows a top view (top) and side view (bottom) of the structure.

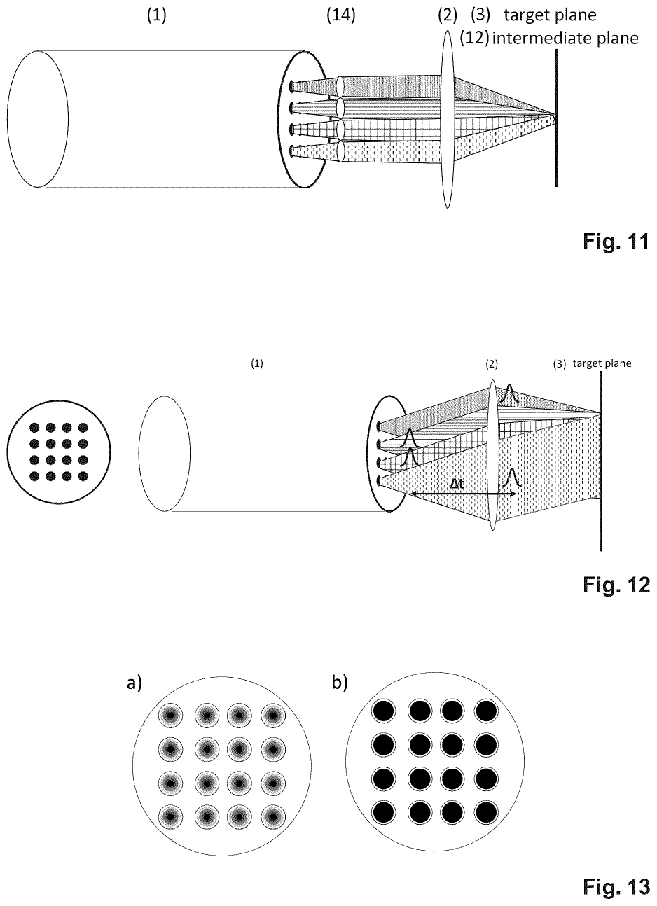

In the embodiment of FIG. 11, a lens array 14, optionally a microlens array, is used behind the multi-channel light guide 1, whereby ideally one microlens is placed in the beam path of each individual emission. With this approach, the beam diameter of the individual emissions can be changed in relation to their spacing. This makes it possible, for example, to increase the spatial packing density, i.e., the fill factor of the total emission, i.e., the entirety of the individual emissions. Subsequently, the incoherent superposition is performed by means of the superposing optical unit 2 on the target plane 3 or the intermediate plane 12. The microlens array 14 does not necessarily have to be placed directly behind the multi-channel light guide 1, other positions in the beam path are also suitable for adjusting the fill factor. At a greater distance, a classic lens array 14 can also increase the fill factor.

FIG. 12 illustrates that pulses emitted by the individual light guides arrive at the target plane 3 simultaneously or at arbitrarily shifted times (e.g., two groups of pulses with a time difference At).

In addition to the superposing optical unit 2, the multi-channel light guide 1 itself can also be adapted to the subsequent application. So the index profiles of the individual cores of the multi-channel light guide 1, which is designed as an active or passive multi-core fiber, can be adapted to achieve a specific output beam profile, as illustrated in FIG. 13. Thus, in conventional step index fibers, Gaussian-like beam profiles (FIG. 13a) with an adapted index profile form a flat, so-called “flat-top” beam profile (FIG. 13b). There are numerous degrees of design freedom here. The index profile of the individual light guides can be adapted to find a compromise between the distance of the individual emissions, the beam quality of the individual emissions and the coupling of the individual emissions. Special fiber designs of the individual light guides are also possible, e.g., as photonic crystal fibers or large-pitch fibers.

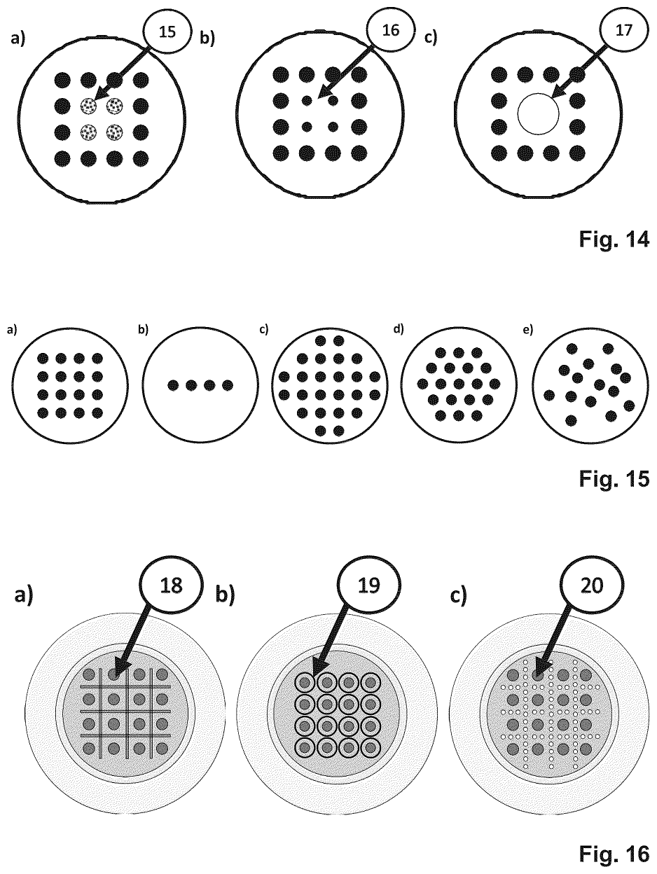

Furthermore, different dopants 15 (e.g., ytterbium, erbium or thulium) can be introduced into the cores of the different individual light guides, as shown in FIG. 14a. This makes it possible to emit at different wavelengths by simply switching the pump wavelength, whereby the individual emissions are superposed incoherently. It should be noted that different core diameters of the individual light guides can be selected for different wavelengths in order to achieve the same spot diameter during superposition. For example, the emission wavelength for doping with thulium is approx. 2 μm, which means that the beam parameter product is by definition a factor of two worse than the emission at 1 μm (even assuming diffraction-limited beam quality). However, the longer wavelength also allows a core diameter that is a factor of two larger with an unchanged V parameter and thus an unchanged number of modes in the individual light guide.

In general, the geometry of the cores of the individual light guides can be designed differently. In FIG. 14b, cores of different sizes 16 are introduced into the multi-channel light guide, resulting in beams of different diameters on the target plane 3. This can be combined with the use of different dopants in the individual light guides so that different emission wavelengths can generate different spot sizes and thus intensities in the target plane 3. In addition to the use of conventional active or passive cores of the individual light guides, it is also possible to integrate one or more passive (optionally gas-filled) hollow-core waveguides 17, as shown in FIG. 14c.

The arrangement of the individual light guides across the cross-section of the multi-channel light guide is not limited to a rectangular pattern, as illustrated in FIG. 15a. A linear pattern (FIG. 15b) or a polygonal pattern (FIG. 15c) are also possible. Hexagonal positioning of the individual light guides (FIG. 15d), for example, increases the fill factor of the total emission. A random positioning of the individual light guides, even with different distances between the cores, as shown in FIG. 15e, is also possible in principle.

If the core spacing of the individual light guides in the active or passive multi-channel light guide 1 of the disclosure is small, optical coupling between the individual light guides can be avoided or reduced by introducing optical barriers. For example, as illustrated in FIG. 16, this can be achieved by using materials 18, 19 with different refractive indices (FIG. 16a and FIG. 16b), or by using air holes 20 (FIG. 16c) between or around the individual cores.

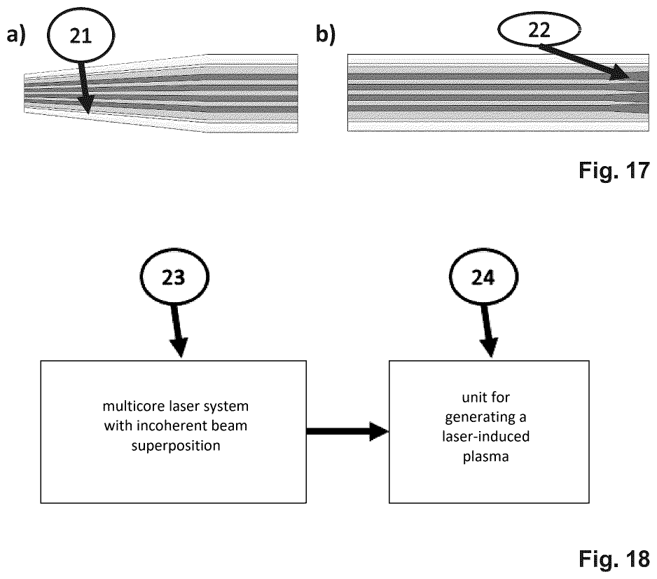

In addition to the transverse structure of the multi-channel light guide 1, the longitudinal structure can also be adapted. For example, the diameter can be changed in a section, as shown in FIG. 17a, or over the entire length (“taper” 21), which can positively influence the beam quality of the individual emissions. This tapering can take place, for example, in the multi-channel light guide 1 as a multi-core oscillator 5, but for example, also in the multi-core amplifier 7 or in the multi-core transport fiber 8. Changing the emission size of the individual cores with (optionally) unchanged outer diameter of the multichannel waveguide 1 can increase the fill factor of the total emission. This is shown schematically in FIG. 17b at 22. Both an increase in the size of the individual cores at the outlet end (associated with a reduction in the spacing of the cores) and a reduction in the size of the individual cores (associated with an increase in the mode area with the same core spacing) can have a positive influence on the fill factor.

Finally, FIG. 18 illustrates the generation of a laser-induced plasma in gases or solids for the purpose of frequency conversion at 24 as a selected application of the optical system according to the disclosure. The incoherent superposition of the individual emissions with good overall beam quality and homogeneous intensity profile in the target plane 3 is ideally suited for the incoherent frequency conversion process. Power densities in the range of 1011 W/cm2 on a wide variety of metals generate plasmas that emit in the extreme ultraviolet (EUV) spectral range, but also in the soft X-ray range; at intensities of 1017 W/cm2, emissions in the hard X-ray range are possible.

The disclosure provides an optical system, for example a high-power laser system, which mitigates or avoids at least some of the disadvantages mentioned above.

1. An optical system for generating or guiding light, the optical system comprising:
a multi-channel light guide that includes a plurality of individual light guides running parallel to one another; and
a superposing optical unit configured to superpose light emissions from the plurality of individual light guides in a target plane at an outlet end of the multi-channel light guide,
wherein the superposition of the light emissions of the plurality of individual light guides is incoherent in the target plane.

2. The optical system according to claim 1, wherein the plurality of individual light guides have a linear-shaped or array-shaped arrangement as seen in the cross-section of the multi-channel light guide.

3. The optical system according to claim 1, wherein each of the plurality of individual light guides are formed by a light-guiding core or another light-guiding structure.

4. The optical system according to claim 3, wherein at least one of the light-guiding cores or light-guiding structures that form the plurality of individual light guides is surrounded by a common cladding of the multi-channel light guide.

5. The optical system according to claim 4, wherein at least one of the light-guiding cores comprise a doping with ions of rare earths to enable optical amplification.

6. The optical system according to claim 5, wherein at least one of the light-guiding cores differ from another of the light-guiding cores in terms of doping.

7. The optical system according to claim 5, wherein the common cladding is adapted to guide pump light for optically pumping the at least one doped core.

8. The optical system according to claim 3, wherein at least two of the light-guiding cores have different diameters.

9. The optical system according to claim 3, wherein at least one of the light-guiding cores is formed as a hollow core.

10. The optical system according to claim 1, wherein the individual light guides are doped light-conducting fibers.

11. The optical system according to claim 1, wherein the individual light guides are optically decoupled from each other.

12. The optical system according to claim 1, wherein the light emissions of the individual light guides are almost diffraction-limited.

13. The optical system according to claim 1, wherein the superposing optical unit is variable and configured to generate different beam profiles in the target plane.

14. The optical system according to claim 1, wherein the superposing optical unit comprises a lens array, and each lens of the lens array is associated with one or more individual light guides.

15. The optical system according to claim 1, wherein the individual light guides each form a laser medium in an optical resonator.

16. The optical system according to claim 15, further comprising a light modulator arranged inside or outside the resonator that is configured to generate a temporal modulation of a laser emission.

17. The optical system according to claim 1, comprising two or more multi-channel light guides, wherein the superposing optical units respectively associated with the multi-channel light guides are configured to superpose the emissions of the two or more multi-channel light guides in a spatial region.

18. The optical system according to claim 1, further comprising a non-linear optical element provided for frequency conversion of the superposed light emissions of the individual light guides.

19. Use of the optical system designed as a laser system according to claim 1 any one of claims 1 to 18 for
generating UV light from a laser-induced metal plasma or gas plasma,
material processing by laser shock peening,
Separation of a film from a substrate by laser lift-off, or
fragmentation of kidney or bladder stones by exposure to laser pulses (lithotripsy).
